(19) United States
(12) Patent Application Publication
(10) Pub. No.: US 2007/0254971 A1
(43) Pub. Date: Nov. 1, 2007

(54) FOAMABLE THERMOPLASTIC VULCANIZATE BLENDS, METHODS, AND ARTICLES THEREOF

(76) Inventors: Synco De Vogel, Neckargemuend (DE); Kevin Cai, Arlington, TX (US)

Correspondence Address: WINSTON & STRAWN LLP;PATENT DEPARTMENT, 1700 K STREET, N.W., WASHINGTON, DC, 20006, US

(21) Appl. No.: 11/740,085

(22) Filed: Apr. 25, 2007

Related U.S. Application Data
(60) Provisional application No. 60/796,219, filed on May 1, 2006.

(51) Int. Cl. C08J 9/16

(52) U.S. Cl. 521/59

(57) ABSTRACT

Thermoplastic vulcanizate blends, or a reaction product thereof, that include at least one propylene resin, at least one ethylene/alpha-olefin/non-conjugated diene elastomer, a curing system, and at least one co-agent may be formed into a foamed blend by the addition of a plurality of expandable polymeric microspheres. Methods of forming such foamed blends and resultant articles are also included. Compared to an equivalent non-foamed blend, such foamed blends are characterized by features that may include low thermal conductivity and decreased density in a closed cell structure with accompanying small cell size, good processability, and colorability.

### CROSS-REFERENCE TO PRIOR APPLICATION

This application claims the benefit of U.S. Provisional Patent Application No. 60/796,219, filed on May 1, 2006, the entire disclosure of which is hereby incorporated herein by express reference thereto.

### TECHNICAL FIELD

This invention relates to foamable thermoplastic vulcanizate blends, or a reaction product thereof, more particularly to a foamable thermoplastic vulcanizate blend containing expandable polymeric microspheres encapsulating a gas, liquid, or solid propellant. The invention further relates to methods of making foamed material from the blends, the resultant foams having a closed cell type structure, and articles made therefrom.

### BACKGROUND OF THE INVENTION

Cellular plastics or plastic foams typically consist of a minimum of two phases: a solid polymer matrix that is either homogeneous or heterogeneous in nature and a gaseous phase derived from a blowing or foaming agent. The structure of the cells or voids of the resulting foam are typically dependent on the process used in the production of the foamed plastic and may be classified as either an open cell type or a closed cell type. In the open cell structure, the voids are connected to one another, whereas in the closed cell structure the voids are individually surrounded by the solid polymer matrix.

Foams which contain a majority of open cell structures typically offer little resistance to the passage of liquids and gases and are thus of little practical value in the areas of thermal insulation and weather resistance, where low thermal conductivity and low moisture absorbance is preferred. Foams made from thermosetting or crosslinking polymers (i.e., thermosets) may form closed cell structures, but such polymers cannot be readily reprocessed once the product is initially formed. U.S. Pat. No. 3,849,350, for example, discloses a syntactic foam prepared with epoxy resin, an aromatic amine curing agent, and hollow glass beads wherein the mixture is dissolved in a solvent and then freeze dried before curing at a temperature from about 100° C. to 129° C.

Thermoplastic vulcanizate (“TPV”) materials formed from blends of cured rubber and polyolefins are known in the art. The structure of such materials is in the form of a matrix containing a plastic component with discrete domains of a partially or fully cured elastomeric component embedded therein, although a co-continuous morphology or a phase inversion may also be possible. Olefin-based thermoplastic vulcanizates have the advantage of being able to undergo plastic flow above the softening point of the polyolefin, and yet behave like a cured elastomer below the softening point, exhibiting desirable rubber-like properties, such as resilience. Dynamic vulcanization, as opposed to static vulcanization (i.e., sulfur vulcanization or electron beam irradiation), is a process whereby the elastomeric portion of the thermoplastic vulcanizate is cured by heating the blend in the presence of a curative while shearing the blend. Conventional curing methods that may be used to partially or fully cure the elastomeric/rubber portion during dynamic vulcanization include phenolic-, peroxide- and siloxane-based systems.

Foamable thermoplastic vulcanizates and foamed profiles made therefrom are known in the art. The type of curative system (i.e., phenolic-, peroxide, or siloxane-based) should be carefully chosen, however, when foamed profiles with low moisture absorbance and low thermal conductivity are desired. Phenolic resin cured TPVs, for example, tend to demonstrate a high degree of moisture absorbance, which typically results in a high, and therefore undesirable, thermal conductivity.

EP 0503220 B1, for example, discloses the foaming of commercial thermoplastic elastomers such as those manufactured and sold by Advanced Elastomer Systems under the registered trademark of SANTOPRENE. This process requires heating the thermoplastic elastomer to a temperature above its melting point using a single screw extruder equipped with a die. After the thermoplastic elastomer is melted, water is injected under pressure into the extruder using a special screw design. The water and melted thermoplastic elastomer are mixed, and the composition is then released to atmospheric pressure, usually through a shaping die, producing a foamed profile.

Foamable TPV materials with closed cell structure are known in the art. The prominent example of this is the so-called MUCELL technology, which requires expensive, specialized equipment and is not suitable for extruding large-sized parts. U.S. Pat. No. 6,051,174, for example, discloses an extrusion process to produce a microcellular material which includes the formation of a polymer/supercritical fluid solution formation under pressure and the inducement of a thermodynamic instability through a rapid pressure drop, (e.g., higher than 0.9 GPa/s) to nucleate microcells in the solution.

Foamable thermoplastic vulcanizate materials are also known where relatively high temperatures are normally required for the foaming process, thus limiting their use on an industrial scale. U.S. Pat. No. 6,750,292, for example, discloses a foamable thermoplastic vulcanizate that is processed into a foamed article using a general purpose screw extruder with a diameter of 25 mm and an L/D of 25, wherein the temperature in the first zone of the extruder was 220° C., the temperature in the second zone varied from 245° C. to 260° C., and the temperature in the third zone was 165° C.

It is desired to provide a foamable thermoplastic vulcanizate blend, and articles produced therewith, that is characterized by low thermal conductivity, low moisture absorbance, good resiliency, and lower processing temperatures compared to an equivalent unfoamed blend or article.

### SUMMARY OF THE INVENTION

The invention encompasses a foamable thermoplastic vulcanizate blend, or reaction product thereof, that includes at least one propylene resin and at least one ethylene/alpha-olefin/non-conjugated diene elastomer, wherein the foamable thermoplastic vulcanizate blend has been dynamically vulcanized via a free-radical initiated or phenolic-based curing system including at least one crosslinking agent and at least one co-agent present in an amount sufficient to cure the thermoplastic vulcanizate blend; and a sufficient amount of expandable polymeric microspheres dispersed therein that each encapsulate a gas, liquid, or solid to form a foamed thermoplastic vulcanizate blend having a decreased thermal conductivity upon expansion of the microspheres.

In another aspect, the invention encompasses foamed thermoplastic vulcanizate polymer blends, and reaction products thereof, including at least one propylene resin present in an amount from about 10 weight percent to about 85 weight percent and at least one ethylene/alpha-olefin/non-conjugated diene elastomer present in an amount from about 5 weight percent to about 90 weight percent, based on the total weight of the polymer component in the blend, wherein the blend has been dynamically vulcanized via a free-radical initiated curing system or phenolic-based curing system, and wherein the thermal conductivity of the thermoplastic vulcanizate blend has been decreased by the addition of a sufficient amount of expanded polymeric microspheres.

In one preferred embodiment, the curing system is free-radical initiated and further includes at least one co-agent including one or more of the following: multifunctional vinyl monomers, multifunctional acrylates containing at least two acrylate groups, multifunctional methacrylates containing at least two methacrylate groups, metal salts of acrylic esters or methacrylic esters, oximers, allyl esters of cyanurates, isocyanurates, aromatic acids, high vinyl polydienes or polydiene copolymers, multifunctional maleimides containing at least two imide groups, or any combination thereof. In another embodiment, the free radical initiated curing system further includes a first co-agent including one or more diene-containing polymers with a 1,2-vinyl content greater than about 30% by weight, and a second co-agent including a multifunctional acrylate containing at least two acrylate groups, a multifunctional maleimide containing at least two imide groups, or a mixture thereof. In another preferred embodiment, the curing system is phenolic-based and the at least one co-agent includes a metal oxide, metal halide, metal carboxylate, or a combination thereof.

In another aspect, the invention encompasses methods for preparing foamed thermoplastic vulcanizate blends by dry blending a thermoplastic vulcanizate blend, or a reaction product thereof, with an amount of expandable polymeric microspheres, and melt blending the thermoplastic vulcanizate blend and the amount of expandable polymeric microspheres at a processing temperature from about 120° C. to 205° C. to foam the blend into a foamed thermoplastic vulcanizate blend, wherein the amount of microspheres is sufficient to provide the foamed blend with a thermal conductivity of less than about 0.19 W/(m K). In yet another embodiment, the invention encompasses a method for preparing a foamed thermoplastic vulcanizate blend by dynamically vulcanizing a thermoplastic vulcanizate blend, or a reaction product thereof, in a mechanical mixer or extruder, subsequently adding a sufficient amount of expandable polymeric microspheres to the dynamically vulcanized vulcanizate blend, and further melt blending the thermoplastic vulcanizate blend with the amount of expandable polymeric microspheres at a processing temperature from about 120° C. to 205° C. to foam the blend into a foamed thermoplastic vulcanizate blend, wherein the amount of microspheres is sufficient to provide the foamed blend with a thermal conductivity of less than about 0.19 W/(m·K). In a preferred embodiment, the method further includes extruding the foamed blend through a die.

In one preferred embodiment, the melt blending includes a first melt blending at a temperature below about 120° C. to sufficiently disperse the expandable microspheres in the thermoplastic vulcanizate blend so that a substantially uniform foam can be generated; and a second melt blending at the temperature from about 120° C. to 205° C. to foam the blend into a foamed thermoplastic vulcanizate blend.

In a further aspect, the invention encompasses methods for preparing foamed thermoplastic vulcanizate blends by dry blending a thermoplastic vulcanizate blend, or a reaction product thereof, with an amount of expandable polymeric microspheres containing a propellant therein that expands the microspheres upon at least one triggering event, and triggering expansion of the propellant in the microspheres to expand the microspheres sufficiently to foam the blend into a foamed thermoplastic vulcanizate blend, wherein the amount of microspheres and the expansion thereof are each sufficient to provide the foamed blend with a thermal conductivity of less than about 0.19 W/(m·K).

In one embodiment, the method further includes melt blending the thermoplastic vulcanizate blend and the expandable polymeric microspheres to provide a substantially uniform dispersion of the microspheres throughout the blend. In yet another embodiment, the triggering includes heat that is provided by molding or extruding the thermoplastic vulcanizate blend and the expandable polymeric microspheres to form the foamed blend.

The invention also encompasses the foamed thermoplastic vulcanizate blends produced by these methods. In yet a further aspect, the invention encompasses articles, e.g., an extruded sheet, film, or tape, of foamed thermoplastic vulcanizate having the low thermal conductivity and low moisture absorbance, which can be prepared according to the methods herein. In another aspect, the invention encompasses injection molded articles. In yet a further aspect, the invention encompasses weather seals formed from the foamed TPV blends.

In one embodiment, the blends further include a sufficient amount of expandable polymeric microspheres encapsulating a gas, liquid, or solid to form a foamed thermoplastic vulcanizate blend having a decreased thermal conductivity. In one embodiment, the expandable polymeric microspheres are present in an amount from about 0.001 weight percent to about 30 weight percent, based on the total weight of the polymers in the blend. In one embodiment, the thermal conductivity of the foamed thermoplastic vulcanizate blend is less than about 0.19 W/(m·K). In a preferred embodiment, the thermal conductivity of the foamed thermoplastic vulcanizate blend is from about 0.01 W/(m·K) to about 0.16 W/(m·K). In one preferred embodiment, the invention includes dynamically vulcanizing a thermoplastic polymer blend comprising at least one propylene resin and at least one ethylene/alpha-olefin/non-conjugated diene elastomer; and pelletizing the blend before dry blending with the expandable polymeric microspheres. In another embodiment, the triggering includes the application of heat, a change in pressure, or a combination thereof, to expand the propellant in the microspheres, thereby expanding the microspheres.

In yet a further aspect, the invention encompasses a thermally insulated pipe comprising a pipe and an extruded, thermally insulating tape comprising the foamed thermoplastic vulcanizate blend disposed, e.g., by winding, around a portion of the pipe. Methods of insulating pipes by disposing any foamed TPV blend of the invention about a portion of such pipes, e.g., by direct extrusion onto the pipe, are also included in the invention. The invention also encompasses thermally insulated pipe including a pipe and an extruded, thermally insulating layer that is formed from at least the foamed thermoplastic vulcanizate blend disposed around a portion of the pipe.

It should be understood that each of these embodiments apply to some or all aspects of the invention described herein.

### DETAILED DESCRIPTION OF THE PREFERRED EMBODIMENTS

It has now been discovered that foamable thermoplastic vulcanizate blends having one or preferably several of the following characteristics, including low thermal conductivity, low moisture absorbance, closed cell structure with accompanying small cell size, lower relative density, and good processability, may be achieved through the addition of expandable polymeric microspheres that encapsulate a gas, liquid, or solid, preferably as a propellant to facilitate microsphere expansion. These characteristics, particularly low thermal conductivity, are surprisingly and unexpectedly lower than conventional TPV blends. In addition, the foamable TPV blend preferably exhibits comparable resilience, low moisture absorbance, good flexibility, good oil swell resistance, and colorability.

The TPV blend of the present invention includes a polymer blend. While any suitable TPV blends according to the invention may be used in preparing the foamable TPV blend or the foamed TPV blend, or articles thereof, a preferred type of thermoplastic vulcanizate blend and methods for making such blends are described in, for example, U.S. Pat. No. 6,890,990, which is incorporated herein by express reference thereto. The polymer blend preferably includes at least one propylene resin and at least one ethylene/alpha-olefin/non-conjugated diene elastomer. Any conventional curing method may be used to partially or fully cure the elastomeric/rubber portion during dynamic vulcanization, including phenolic-, free radical-, and siloxane-based systems. In addition, one or more co-agents are preferably matched with the curing system to enhance the crosslinking properties of the curing agent. For example, in one preferred embodiment the blend has been dynamically vulcanized via a curing system that includes a free radical initiator component, a first co-agent including one or more diene-containing polymers with a 1,2-vinyl content greater than about 30% by weight and substantially free of ethylene, and a second co-agent including at least one multifunctional acrylate containing at least two acrylate groups, at least one multifunctional maleimide containing at least two imide groups, or both. In another preferred embodiment, the blend has been dynamically vulcanized via a curing system that includes at least one formaldehyde/phenolic resin and at least one co-agent that includes a metal oxide, metal halide, metal carboxylate, or a combination thereof.

The “propylene resin” can be present in amounts from about 10 to 85% by weight, preferably about 11 to 70% by weight, and more preferably about 12 to 65% by weight, based on the total weight of the polymer component in the blend, and is chosen from one or more of the following of homopolymers of propylene, copolymers of at least 60 mole percent of propylene and at least one other C₂ to C₂₀ alpha-olefins, or mixtures thereof. Preferred alpha-olefins of such copolymers include ethylene, 1-butene, 1-pentene, 1-hexene, methyl-1-butenes, methyl-1-pentenes, 1-octene and 1-decene or combinations thereof.

Preferably, the copolymer of propylene can include a random or block copolymer. Random copolymers of propylene and alpha-olefins, when used, generally include macromolecular chains in which the monomers are distributed statistically. The block copolymers can include distinct blocks of variable composition; each block including a homopolymer of propylene and at least one other of the above-mentioned alpha-olefins. Although any suitable copolymerization method is included within the scope of the invention, heterophasic copolymers with propylene blocks are generally obtained by polymerization in a number of consecutive stages in which the different blocks are prepared successively.

The melt flow rate (MFR) of the propylene polymer used in the present invention is preferably in a range from 0.01 to 200 g/10 minutes (load: 2.16 kg at 230° C., according to ASTM D-1238-01). The isotacticity of the propylene homopolymer (i.e., the propylene homopolymer or the propylene homopolymer block portion of the block copolymer) is typically greater than about 80%, and preferably greater than about 90%.

Exemplary propylene homopolymers or copolymers are commercially available as, for example, various types of polypropylene homopolymers and copolymers from ExxonMobil Chemicals Company of Houston, Tex., from Basell North America, Inc. of Wilmington, Del., from Borealis A/S from Lydgby, Denmark, from Sunoco Chemicals of Pittsburgh, Pa., and from Dow Chemical Company of Midland, Mich.

The ethylene terpolymer elastomer (ethylene/alpha-olefin/non-conjugated diene) is present from about 5 to 90% by weight, preferably about 6 to 85% and more preferably about 7 to 75% by weight (excluding oil), based on the total weight of the polymer component in the blend, and is chosen from terpolymers containing from about 40 to 75% by weight ethylene, from about 20 to 60% by weight of a C₃ to C₂₀ alpha-olefin component, and from about 1% to 11% by weight of non-conjugated diene monomer. The alpha-olefin component includes one or more C3 to C20 alpha-olefins, with propylene, 1-butene, 1-hexene, and 1-octene preferred, and propylene being most preferred for use in the ethylene elastomer.

Examples of suitable non-conjugated diene monomers include straight chain, hydrocarbon di-olefin or cylcloalkenyl-substituted alkenes having from 6 to 15 carbon atoms, or combinations thereof. Specific preferred examples include one or more classes or species including (a) straight chain acyclic dienes such as 1,4-hexadiene; (b) branched chain acyclic dienes such as 5-methyl-1,4-hexadiene; (c) single ring alicyclic dienes, such as 1,4-cyclohexadiene; (d) multi-ring alicyclic fused and bridged ring dienes such as dicyclopentadiene (DCPD), 5-methylene-2-norbomene (MNB), and 5-ethylidene-2-norbornene (ENB); (e) cycloalkenyl-substituted alkenes, such as allyl cyclohexene; or a combination thereof. Of the non-conjugated dienes typically used, the preferred dienes are dicyclopentadiene, 1,4-hexadiene, 5-methylene-2-norbornene, and 5-ethylidene-2-norbornene, or a combination thereof.

The elastomer without any oil extension typically has a Mooney viscosity (ML 1+4, 125° C.), as measured by ASTM D- 1646-00, of at least about 100. The elastomer with oil extension typically has a Mooney viscosity of at least about 15; with a molecular weight greater than about 80,000; and with a density generally ranging between about 0.85 to 0.95 g/cm³. Elastomeric terpolymers of ethylene/propylene/diene (EPDM) are preferred. Exemplary elastomers are commercially available as NORDEL from Dow Chemical Company of Midland, Mich., as VISTALON from ExxonMobil Chemicals of Houston, Tex., as DUTRAL from Polimeri Europa Americas of Houston, Tex., as BUNA EP from Lanxess Corporation of Pittsburgh, Pa., or as ROYALENE from Crompton Corporation of Middlebury, Conn.

The elastomer curing system preferably contains a phenolic-, free radical- or siloxane-based system combined with one or more co-agents. One or more co-agents, if used, may function as a mediator, accelerator, or catalyzer, or a combination thereof, to facilitate the partial or full curing of the elastomer phase in the presence of the crosslinking or curing agent. The curing system in one embodiment is preferably a free radical initiator or crosslinking agent chosen so that a sufficient amount of radicals are generated to substantially cure, preferably fully cure, the elastomer during the melt mixing (e.g., dynamic vulcanization) process. The free radical initiator is present in amounts from about 0.001 to 2% by weight, with about 0.01 to 1% being preferable and about 0.03 to 0.3% being most preferable, based on the total weight of the polymer component in the blend. Typically, the free radical initiator may be organic peroxides or organic azo (e.g., diazide) compounds or any mixtures thereof.

Free radical initiators useful for this invention, preferably one or more organic peroxides, should have a decomposition half-life of greater than about one hour at 120° C. Representative peroxides that are useful are peroxyketals such as 1,1-bis(t-butylperoxy)-3,3,5-trimethylcyclohexane; dialkyl peroxides such as di-t-butyl peroxide, dicumyl peroxide, t-butylcumyl peroxide, 2,5-dimethyl-2,5-bis(t-butylperoxy)hexane; diacyl peroxides such as acetyl peroxide.; peroxyesters such as t-butyl peroxybenzoate; hydroperoxides such cumene hydroperoxide; or any combination thereof. Among these compounds, dialkyl peroxides with a half life of greater than one hour at 120° C. are preferable. Half-life is defined as the time required to reduce the original peroxide concentration by half.

The peroxide-based co-agent, if one or more are used, may function by reacting with the radicals formed from decomposition of a peroxide or azo compound to form free radicals on the co-agent molecule, which then mediate the crosslinking reaction. Typically, these co-agent materials contain di- or poly-unsaturation and have a readily extractable hydrogen in the alpha position to the unsaturated bonds. Co-agents used in the peroxide-based elastomer curing system can preferably be present in amounts from about 0.1 to 20% by weight, preferably from about 0.5 to 13% by weight, and most preferably from about 0.7 to 10% by weight, based on the total weight of the polymer component in the blend. Preferred co-agents typically include, but are not limited to, one or more multifunctional vinyl monomers such as divinylbene; one or more multifunctional acrylates containing at least two acrylate groups such as trimethylolpropane triacrylate, ethoxylated trimethylolpropane triacrylate, propoxylated trimethylolpropane triacrylate, propoxylated glyceryl triacrylate, pentaerythritol triacrylate, cyclohexane dimethanol diacrylate, pentaerythritol tetraacrylate, ethoxylated pentaerythritol tetraacrylate, ethylene glycol diacrylate, di-trimethylolpropane tetraacrylate, and pentaerythriotoltriacrylate; one or more multifunctional methacrylates containing at least two methacrylate groups such as trimethylolpropane trimethacrylate and ethyleneglycol dimethacrylate; one or more metal salts of acrylic esters or methacrylic esters such as zinc diacrylate and zinc dimethacrylate; one or more oximers such as p-quinone dioxime and p,p′-dibenzoylquinone dioxime; one or more allyl esters of cyanurates, isocyanurates, and aromatic acids such as triallylcyanurate, triallylisocyanurate, and triallyltrimellitate; one or more high vinyl polydienes or polydiene copolymers such as high vinyl 1,2-polybutadiene, atactic high vinyl 1,2-polybutadiene, syndiotactic high vinyl 1,2-polybutadiene, and high vinyl solution styrene-butadiene elastomers; one or more multifunctional maleimides containing at least two imide groups such as phenyl-maleimide, N,N′-m-phenylene-bismaleimide, 3,3′-bismaleimido-diphenylmethane, and 4,4′-bismaleimido-diphenylmethane, or a combination thereof. The term “high vinyl” is herein defined as a 1,2-vinyl content greater than 30% and preferably additionally substantially free of ethylene. Any of the above-noted cross-linking co-agents may be used in combination of several kinds of cross-linking co-agents (e.g., a first co-agent of a 1,2-polybutadiene and a second co-agent of multifunctional acrylates containing at least two acrylate groups).

One or more phenolic resins, or mixtures thereof, may alternatively or additionally be used in a curing system according to the invention. These phenolic resins, also referred to as resole resins, are also known crosslinking agents for unsaturated elastomers and have been employed to cure the elastomer component of thermoplastic vulcanizates as set forth in, for example, U.S. Pat. No. 4,311,628, which is hereby incorporated herein by express reference thereto. The phenolic resin curative or crosslinking agent is typically present in an amount of about 1 to 20 parts by weight per 100 parts by weight elastomer. Preferred phenolic resin curatives may be made by the condensation of alkyl substituted phenols or unsubstituted phenols with aldehydes, preferably formaldehydes, in an alkaline medium or by condensation of bi-functional phenoldialcohols. Phenolic resins that are useful in the practice of the present invention may be obtained, for example, under the tradenames SP-1044, SP-1045, SP-1055, and SP-1056 (Schenectady International; Schenectady, N.Y.). In addition, one or more co-agents may be used to accelerate a phenolic-based curing system and each is present in an amount of about 0.1 to 10 parts by weight per 100 parts by weight elastomer. Preferred phenolic-based co-agents include one or more of the following: metal oxides such as zinc oxide, metal halides such as zinc chloride or stannous chloride; metal carboxylates such as zinc stearate, zinc benzoate, zinc laurate, zinc chromate, zinc silicate, zinc carbonate, stannous stearate, stannous benzoate, stannous laurate, stannous chromate, stannous silicate, stannous carbonate; or combinations thereof.

Hydrosilylation, or siloxane-based curing systems, have also been disclosed as a suitable crosslinking method and is described in, for example, U.S. Pat. No. 5,672,660, which is hereby incorporated by express reference thereto. In this method, a silicon hydride having at least two SiH groups in the molecule is reacted with the double bonds of the unsaturated elastomer phase in the presence of a co-agent such as a hydrosilylation catalyst. Silicon hydride compounds useful in the process of the invention include methylhydrogen polysiloxanes, methylhydrogen dimethyl-siloxane copolymers, alkyl methyl polysiloxanes, bis(dimethylsilyl)alkanes and bis(dimethylsilyl)benzene. Hydrosilylation catalysts typically include the transition metals of Group VIII such as palladium, rhodium, platinum and the like, including complexes of these metals.

Additives for use in the present invention include, for example, any suitable additives for conventional TPVs, such as processing or extender oils, fillers, organic and inorganic pigments, carbon black, heat stabilizers, antioxidants, or ultraviolet light absorbers. The thermoplastic vulcanizate blend is preferably non-hygroscopic and therefore typically needs no drying prior to processing.

When included in the TPV blends, extender oils with a high degree of saturation and a kinematic viscosity at 40° C. greater than about 20 centi-Stokes are typically used. Saturated extender oils with paraffinic content greater than about 40%, when measured with method ASTM D-2140-97, are preferred. One of ordinary skill in the art of processing of elastomers will readily recognize the type and amount of oil that would be most beneficial for any given application. The extender oils, when used, are desirably present in an amount of about 4 to 65% by weight, preferably from about 5 to 60% by weight, and most preferably from about 10 to 55% by weight based on the total weight of the polymer component in the blend.

The suitable TPV blend is also combined with a plurality of expandable polymeric microspheres, preferably heat expandable microspheres, that preferably includes a polymer shell that encloses one or more hollow spaces in a central portion thereof. The polymer shell is preferably predominantly at least one thermoplastic material that encapsulates a gas, liquid, or solid propellant entrapped therein in any hollow space. The microspheres are preferably present in amounts from about 0.001 weight percent to about 30 weight percent, preferably in an amount from about 0.01 weight percent to about 20 weight percent, and more preferably from about 0.1 weight percent to about 10 weight percent, based on the total weight of the polymer component in the blend. In one embodiment, the heat expandable polymeric microspheres are present in an amount from about 0.1 weight percent to about 5 weight percent. The propellant is normally a liquid having a boiling temperature that is no higher than the softening temperature of the thermoplastic polymer shell. In one embodiment, the TPV blends preferably are substantially or entirely free of any thermal expansion aides, such as added water, because the expandable microspheres typically expand without additional chemical constituents.

Upon a triggering event, e.g., by the application of heat or by a change in pressure change, or a combination thereof, the propellant evaporates or otherwise expands to increase the internal pressure, which can result in significant expansion of the microspheres, normally from about 2 to about 12 times their original diameter, preferably from about 3 to 10 times their original diameter. Other triggering events known to those skilled in the art include the application of ultrasonic energy, light energy of particular wavelength(s), radio frequency (“RF”) energy, or the like, or any combination thereof. Microspheres can be partially expanded before addition to the TPV blend, or can be expanded in one or more triggering events, but preferably are unexpanded upon addition to the TPV and expanded through a single triggering event of one or more types of energy. The triggering event is preferably heat, which can permit the shell to soften at the same time the propellant expands.

The starting temperature (Tₛₜₐᵣₜ) for the expansion of suitable heat expandable polymeric microspheres, for example, is from about 80° C. to about 170° C., more preferably from about 105° C. to about 160° C., and most preferably from about 115° C. to about 150° C. The temperature at which maximum expansion of the heat expandable polymeric microspheres is reached (Tₘₐₓ) is preferably higher than about 170° C. and most preferably higher than about 190° C. Normally Tₘₐₓ does not exceed about 220° C. When Tₘₐₓ is exceeded, the shells are often so soft that propellant has been released through the polymer shell to such an extent that the microsphere starts to collapse, although this will depend on the type of polymeric material included in the shell.

Suitable crosslinked or uncrosslinked materials for the thermoplastic polymer shell include any flexible microsphere material available to those of ordinary skill in the art. Preferred thermoplastic polymers for forming the microsphere shell include one or more of acrylonitrile, acrylamide, acrylic esters such as methylacrylate, ethyl acrylate, or ethylene methyl acrylate, methacrylic esters such as methyl methacrylate, vinyl chloride, vinylidene chloride, vinyl esters such as vinyl acetate and ethylene vinyl acetate, styrenes, or a combination thereof. When crosslinkable polymers or reactive oligomers are used for or included in the thermoplastic polymer shell, it is desirable that the crosslinking of the shell polymer is inactive at the onset of the expansion temperature. Thus, crosslinking of crosslinkable thermoplastic polymer shell materials preferably will be activated only at a higher temperature (e.g., 10° C. to 30° C. higher than the expansion temperature when heat energy is provided) when the microspheres are fully expanded to thermoset the shell of the expanded microspheres after expansion thereof.

Suitable propellants include any of those available to one of ordinary skill in the art, preferably one or more of: propanes, butanes, isobutanes, pentanes, isopentanes, isooctanes, hexanes, cyclohexanes, heptanes, and other low-boiling point petroleum distillates, chlorofluorocarbons, hydrofluorocarbons, halogenated methanes such as methyl chloride and methylene chloride, tetralkyl silanes such as tetramethyl silane or trimethylethyl silane, or a mixture of any of these propellants.

The average particle size of the expandable microspheres before expansion is suitably from about 1 μm to about 500 μm, preferably from about 1 μm to about 200 μm, and more preferably from about 3 μm to about 100 μm. By heating to a temperature above Tₛₜₐᵣₜ, it is normally possible to expand the microspheres from about 2 to about 12 times, preferably from about 3 to 10 times, their diameter. Preferably, the microspheres remain substantially in their expanded state, rather than collapsing over time, so as to retain the desired closed cell structure. Moreover, it is preferred that the microspheres preferably not rupture during or after expansion, which also helps generate and preserve the closed cell structure.

The expandable polymeric microspheres are normally prepared by suspension polymerization, although any other suitable method available to those of ordinary skill in the art could be used. A general description of some techniques that may be employed, and a detailed description of heat expandable polymeric microspheres, may be found in U.S. Pat. Nos. 3,615,972, 4,108,806, and 4,483,889, each incorporated herein by express reference thereto. Examples of commercially available heat expandable polymeric microspheres in either powder form or as a masterbatch carried in a low melting point resin are EXPANCEL from Akzo Nobel of Sundsvall, Sweden, DUALITE from Pierce and Stevens of Buffalo, N.Y., and ADVANCELL from Sekisui Chemical Company of Osaka, Japan.

Expandable polymeric microspheres, particularly heat expandable microspheres, used as foaming agents are known. U.S. Pat. No. 6,841,582, for example, discloses a foamed, non-chemically crosslinked thermoplastic elastomer that includes ethylene/alpha-olefin copolymers, crystalline polyethylene resins, hydrogenated block copolymers with an ethylene content greater than 50%, and foaming agents. Polypropylene and other crystalline alpha-olefins having 3 or more carbon atoms may be optionally added in amounts of less than 10% by mass.

The foamed profile formed by the addition of expandable polymeric microspheres, preferably heat expandable, to the foamable thermoplastic vulcanizate blend of the present invention is typically characterized by thermal conductivity from about 0.01 W/(m·K) to about 0.19 W/(m·K), preferably from about 0.025 W/(m·K) to about 0.16 W/(m·K), and more preferably from about 0.05 W/(m·K) to about 0.14 W/(m·K). In one exemplary embodiment, the thermal conductivity of foamed blends of the invention is from about 0.025 W/(m·K) to about 0.1 W/(m·K). Thermal conductivity, measured as watt per meter Kelvin [W/(m·K)] according to ASTM C177-97, is defined as the quantity of heat transmitted through a unit thickness in a direction normal to a surface of unit area, due to a unit temperature gradient under steady state conditions. Typical insulation materials exhibit a thermal conductivity, or K-factor, from about 0.035 W/(m·K) to about 0.16 W/(m·K). If moisture intrudes into the insulating material, however, the thermal conductivity may increase, and efficiency may be lost since the K-factor for water is about 0.58 W/(m·K). A single percent increase in moisture content in conventional insulation materials normally equates to approximately a 7.5% increase in thermal conductivity, which undesirably decreases the insulating effect of certain materials. Generally, the thermoplastic vulcanizate blends, whether foamed or unfoamed, have less than about 5 weight, or are preferably substantially free of, moisture content. More preferably, the blends have a moisture content of less than about 2 weight percent. In one exemplary embodiment, the TPV blends have a moisture content of less than about 0.5 weight percent.

The foamed blends of the current invention are further characterized by specific gravity at 23° C., also known as relative density, ranging from about 0.39 to 0.71, preferably from about 0.42 to 0.60. Specific gravity, measured at 23° C. according to ASTM D792-00, is defined as a ratio of the weight of a given volume of a substance to that of an equal volume of water at the same temperature. The relative density of the foamable thermoplastic vulcanizate blend is typically greater than the relative density of the foamed profile formed after the addition and expansion of the expandable polymeric microspheres, and normally ranges from about 0.91 to about 0.98 at 23° C. Articles, components, or parts manufactured from the foamed thermoplastic vulcanizate blends of the current invention are therefore lighter in weight than parts formed from conventional unfoamed TPV material.

The foamed blends of the current invention typically retain the resilience of the unfoamed TPV blend from which it is formed. Resilience (i.e., mechanical stress relaxation) is defined as the degree to which a material may quickly resume its original shape after removal of a deforming stress. Temperature is usually kept constant during a conventional stress relaxation test, where a constant deformation is applied to a sample and the tensile strain is monitored as function of time. Due to the thermoplastic nature of the thermoplastic vulcanizate blend, however, resilience should be measured not only as a function of time, but also as a function of temperature. One method of measuring the resilience of a material as a function of both time and temperature is the temperature scanning stress relaxation (TSSR) test, which measures the thermo-mechanical properties of elastomers and polymers when subjected to a constant tensile strain at a constantly rising temperature, as described in, for example, “New test methods for the characterization of thermoplastic elastomers,” TPE 2004 Conference Proceedings, p. 141-154.

A Brabender® TSSR Meter, for example, may be used to apply a constant tensile strain of at least 50% to a dumbbell test piece, which is placed in the electrically heated test chamber. The test procedure starts with a preconditioning time of two hours after the rapid application of the strain at room temperature. During this time, a decay of most of the short-term relaxation processes occurs, so the sample reaches a quasi-equilibrium state. The chamber is then heated at a constant rate, typically 2° C. per minute, while the force is monitored until the stress relaxation has been fully completed or rupture of the sample has occurred. The resulting stress-temperature curve contains characteristic information about the thermo-mechanical behavior of the sample investigated.

One quantity that may be calculated from the normalized stress-temperature curve is the temperature at which the tensile stress on the sample decreased by 50%, the so-called T50 temperature. Normalization in this case is defined as the quotient F(T)/F₀ that is called here the force ratio, where F(T) is the force at temperature T and F₀ is the initial force determined at start temperature T₀. Thus, the T50 temperature indicates not only the elastic behavior or resilience of a material, but also characterizes the service temperature range of the material. A noncrosslinked thermoplastic polyolefin, for example, typically demonstrates a T50 temperature that is less than 65° C., as these materials tend to begin to soften and lose their resilience at higher temperatures. Although thermoset rubbers typically show a T50 temperature from about 125° C. to about 165° C., foamed thermoset rubber is limited to conventional foaming agents due to typical thermoset rubber processing conditions (i.e., crosslinking occurs at temperatures greater than 200° C. and the crosslinking is irreversible). The T50 temperature of the foamed blends of the present invention is preferably from about 78° C. to about 155° C., more preferably from about 80° C. to about 145° and most preferably from about 81° C.to about 143° C. Thus, the foamed TPV blends of the present invention preferably permit use in hotter environments than most noncrosslinked thermoplastic polyolefins and across most of the temperature range of conventional thermoset rubbers while permitting inclusion of expandable microspheres to facilitate foaming.

Another indicator of resiliency is compression set, which measures the ability of polymeric materials to retain elastic properties at a specified temperature after prolonged compression at constant strain. To measure compression set, a sample was compressed inside spaced sample holders to 40% of its initial height and held at 125° C. for 70 hours according to ISO 815 Type A plied sample (1991). Compression set is reported as a percentage of the initial compression and is determined by the formula: (h₀- h₁)/ (h₀-hₛ)×100, where h₀ is the initial thickness of the sample; h₁ is the thickness of the sample after recovery; and hₛ is the height of the spacer. Material with a compression set of less than 85% at 125° C. shows good elastic properties and is therefore a viable candidate for thermal insulation.

The cell type of the foamed profile of the current invention is preferably a closed cell structure at formation wherein at least about 85% of the cells or voids are of the closed cell type, preferably greater than 95%, and most preferably substantially all of the cells. While 100% closed cells is an ideal, in practice, some small percentage of cells (e.g., up to about 1%, preferably less than 0.1%) will tend to burst upon use of the foamed blend or resultant article, particularly in impact receiving environments. The size of the cells is typically from about 25 μm to about 250 μm, with an average cell size of about 100 μm, and a size distribution that is typically at least substantially uniform, preferably uniform, throughout the foamed blend. The foamed blend demonstrates a relatively small cell size and a more uniform cell distribution that may be provided or processed on conventional extrusion equipment (i.e., no specialized equipment requiring high pressure or high temperature is necessary, although it may be used if desired).

The methods for adding the expandable polymeric microspheres to the foamable thermoplastic vulcanizate blend and for extruding or injection molding a foam profile are not particularly limited. For example, expandable polymeric microspheres may be added via a feed hopper that is located downstream from the section of the mechanical extruder or mixer where the dynamic vulcanization of the thermoplastic vulcanizate blend takes place, and the blend can be further melt-mixed or melt-blended. The purpose of the melt-blending step is to prepare a foamed profile in which the expandable polymeric microspheres, to the extent present, are distributed substantially homogeneously, i.e., substantially or entirely uniformly dispersed, throughout the molten thermoplastic vulcanizate blend. This advantageously facilitates at least substantially uniform distribution of the cells that are formed upon the triggering event that expands a plurality of the expandable microspheres. The temperature, pressure, shear rate, and mixing time employed during melt-blending are readily selected by those of ordinary skill in the art, particularly with reference to the present application, to prepare the foamable TPV blend while minimizing or avoiding breakage or rupture of a significant amount of the microspheres; once broken, the microspheres are unable to expand to create a cell. Breakage or rupture of a sufficient number of expandable microspheres may create an uneven cell distribution, smaller cells, or even a misshapen blend or resultant article.

Alternatively, the thermoplastic vulcanizate blend may be dynamically vulcanized in, for example, a single screw or twin screw extruder, or any other suitable equipment, which is attached in tandem to, e.g., a second single screw or twin screw extruder. The foamable thermoplastic vulcanizate blend may be dynamically vulcanized in the first extruder, and then passed into the second extruder where the expandable polymeric microspheres are added and thoroughly blended.

The triggering event is then activated to expand a substantial portion of the microspheres, and preferably substantially or entirely all of the microspheres, to expand the foam. Preferably, the triggering event is activated before the foamed TPV is formed into a tape or sheet or directly extruded. This may occur through melt blending or heat provided to the resultant melt blend in the case of heat expandable microspheres, or a different triggering event may occur concurrently with, or preferably after the microspheres are substantially blended with the other TPV blend components, so as to create a sufficiently uniform foam upon expansion. This may preferably occur directly after the dry blending and prior to formation of an article with the foamed TPV.

Alternatively, the foamable thermoplastic vulcanizate blend may be dynamically vulcanized in a mechanical mixer or extruder and then pelletized. The expandable polymeric microspheres are then dry blended with the foamable thermoplastic vulcanizate blend and then processed, for example by being melt blended, e.g., in a single screw extruder or a two-stage single-screw extruder, at a processing temperature from about 120° C. to about 200° C. Preferably, because the moisture content of the inventive TPVs is sufficiently low, the TPV blends of the invention can be directly processed including dry blending with the microspheres, or other further processing, without need for drying the TPV blend first. It also should be understood that, once pelletized, the dry blending with expandable polymeric microspheres, the triggering event, or both, can take place in a remote location and/or at a later time. This can advantageously permit transport of the pellets to a desired location before expanding the volume. Preferably, the expandable microspheres are dispersed and expanded within the TPV rather than added at remote location. Preferably, upon expansion, the foamed TPV is exposed to ambient atmosphere.

Following melt-blending or other blending, if not already subjected to a triggering event, the foamable TPV blend may be metered into an extrusion die (e.g., a contact or drop die). The temperature within the die is preferably maintained at or above the temperature required to cause expansion of the expandable microspheres in the case of heat expandable microspheres. The shape of the foam is preferably dictated by the shape of the exit opening of the die. Although a variety of shapes may be produced, the foam is typically produced in the form of a continuous or discontinuous sheet, tape, or film. It can be preferable for most, if not all, of the expandable microspheres to be triggered to expand partially or even substantially entirely before the polymer composition exits the die, while the polymer composition is exiting the die, or after the polymer composition exits the die.

The pressure gradient inside a single screw or twin screw extruder is typically determined by the selection of screws. High pressure (i.e., greater than 3600 psi) is typically required to prevent conventional foaming agents from prematurely expanding prior to releasing the polymer composition to atmospheric temperature and pressure. The use of expandable polymeric microspheres according to the invention, however, typically allows a lower processing pressure. Preferably, as the foamable blend exits the die, the pressure compressing the triggered microspheres in the foam decreases significantly from the extruder pressure down to approximately atmospheric pressure, e.g., 14.7 psi. Once the pressure has decreased significantly, for example, a drop in pressure of about 50 psi to 150 psi, the triggered microspheres are no longer restrained and can rapidly expand as the foamable blend passes through the die. As the blend exits the die, it preferably has achieved the foamed state so that the die can exert influence to help shape the resultant foamed product. For other foam shapes, it may be preferred that the die not exactly match the desired shape but rather that the die will have rounded comers to minimize or avoid extrusion problems and to facilitate cleaning of the extrusion die.

If desired, an optional non-foamed layer of a TPV or other material may be co-extruded with the foamed blend. The co-extrusion method disclosed in U.S. Patent Application No. 2002/055006 is suitable and is expressly incorporated herein by reference thereto. Any other available co-extrusion techniques can be used, such as multiple extrusion heads, or with a multiple manifold flow divider and a single die head.

Alternatively, the TPV blend may be injected into a mold to produce a foamed thermoplastic part. The injection molding equipment preferably is equipped with an auto-shut off nozzle or a needle valve to prevent material from expanding in between the individual shots. Filling of the screw with material should be delayed until just before the next shot in order to reduce the residence time. A variety of other suitable methods of forming the foamed TPV blend are available and may be readily envisioned by those of ordinary skill in the art in view of guidance provided herein.

The foamed TPV blends of the present invention are useful for making a variety of articles, particularly molded or extruded articles having need of the characteristics of the foamed blends, especially the resilience, the low thermal conductivity, and low moisture absorbance. In the automotive field, such articles include weather seals, hoses, belts, gaskets, and energy absorbers. In other fields, e.g., construction, the blends of the invention may be formed into useful articles including insulation for pipes, floors and walls. This can be in dry, land-based applications or even in marine- or maritime based applications where low moisture absorbance is critical to retaining a reduced thermal conductivity.

In particular, the low thermal conductivity of the foamed profile of the present invention provides particularly useful insulation for heating pipes, cooling pipes, flexible tubular pipes for transporting fluids, and underwater pipelines. Underwater, or so-called flexible offshore pipelines, are generally used for the transportation of oil and gas between subsea well-heads to fixed platforms, floating storage facilities, and/or to shore. Offshore pipes are normally very long with so-called flowlines (i.e., flexible pipe resting on the seafloor or buried below the seafloor) often several kilometers in length and so-called risers (i.e., flexible pipe connecting a platform/buoy/ship to a flowline, seafloor installation, or another platform) often several hundred meters in length. For these applications, steel pipes are typically used, although multilayer pipe constructions made of metal and/or polymer-based layers are preferred wherein the separate metal and polymer layers are unbonded, thus allowing relative movement between the various layers. One suitable method for preparing underwater pipelines is disclosed in U.S. Pat. No. 5,601,893, which is hereby incorporated herein by express reference thereto.

At oceanic depths of several hundred meters, however, the temperature of the surrounding water is close to 0° C., leading to extensive heat loss from the transported fluid which is typically extracted at a temperature of about 60 to 120° C. In order to reduce the undesirable heat loss, which may significantly reduce flow or cause blockage of the production lines, an additional insulation layer may be added, typically externally, to the pipe before installation. At the depths in question, the hydrostatic or water pressure on the insulation is substantial, and without sufficient compression strength, the insulating coating will be compressed to a smaller thickness, thereby reducing its insulating capacity. Desirable properties of thermal insulation for offshore pipe therefore typically include low thermal conductivity (i.e., less than about 0.190 W/(m·K)) as well as low compression set to minimize compression and consequently the loss of insulating capacity. In addition, the thermal insulation material typically has a melting temperature from about 142 to 165° C. Conventional foam made of thermoset resin, therefore, is usually not flexible enough for such an application. Conventional syntactic foams made from rigid (i.e., non-compressible) glass microspheres are difficult to process at low enough shear forces to avoid crushing the spheres during the process. As shown in the Examples below, this tends to result in an undesirable increase in thermal conductivity, particularly when such materials are used in underwater insulating applications. Uncrosslinked thermoplastic materials such as thermoplastic polyolefins or reactor grade polyolefins typically provide no elastic recovery at higher temperatures (i.e., high compression set) and are therefore useful as thermal insulation only when hydrostatic pressure is not a factor. Styrenic thermoplastic elastomers (e.g., hydrogenated styrenic block copolymers) that contain physical or ionic crosslinking may be useful as thermal insulation for flexible offshore pipe when foamed through the addition of expandable polymeric microspheres according to the invention.

The foamed profile of the present invention preferably may be extruded, e.g., as a tubular shape directly onto the pipe or, alternatively, extruded tapes of the foamed profile may be wound, shaped, or even formed around the pipe to provide a layer of thermal insulation. The pipe itself may be flexible or rigid. The foamed TPV blends can also be used as an outer insulation layer for pipes or other applications where it is provided with sufficiently low moisture absorbance and the materials it contacts will not tend to degrade the foamed material, or through the application of an additional protective sheath or layer, for example, by extruding or wrapping over the thermal insulation layer. Such a protective sheath or layer would preferably minimize or avoid moisture absorbance, degradation of foamed material in an intermediate layer, or both.

The term “about,” as used herein, should generally be understood to refer to both numbers in a range of numerals. Moreover, all numerical ranges herein should be understood to include each whole integer within the range. When the term “weight percent” is used in reference to a polymer, it refers to the amount in weight percent of the polymer compared to the total amount of polymers in the blend or article. “Essentially free” or “substantially free,” as used herein, refers to no more than about 4 percent, preferably no more than about 1 percent, and more preferably no more than about 0.5 percent of the characteristic referred to. In one preferred embodiment, “essentially free” or “substantially free” refers to less than 0.1 percent. These terms also encompass the absence of any detectable amount as well as the complete absence of the referenced characteristic.

All of the patents and other publications recited in the present application herein are incorporated herein by express reference thereto.

### EXAMPLES

This invention is illustrated by the following examples, which are merely for the purpose of illustration and are not to be regarded as limiting the scope of the invention or the manner in which it can be practiced.

A commercial grade of NEXPRENE 9055A thermoplastic vulcanizate was dry blended with varying amounts of expandable polymeric microspheres, as shown in Table 1. The foamed blend was accomplished using a single screw extruder with L/D of 28:1, a screw compression ratio of 2-3, and a screw speed of 30-45 rpm. Each temperature zone was set to a temperature from about 120° C. to 205° C. The extrusion die had a D-shaped profile, although any type or shape of profile, and any suitable temperature or equipment or settings thereof may be used. Samples were prepared and measured for specific gravity and T50 temperature as described in the text.

Upon expansion, the expandable polymeric microspheres decreased the density of the foamable thermoplastic vulcanizate blend of the current invention. As the surprising and unexpected results show, however, the resilience of the foamable thermoplastic vulcanizate blend was not affected by the addition of the expandable polymeric microspheres to form the foamed blend.

TABLE 1

| | Experiment No. | | |
|---|---|---|---|
| | Ex. 1 | Ex. 2 | Comp. Ex. 1 |
| Curative | Peroxide | Peroxide | Peroxide |
| Foaming agent | Heat | Heat | None |
| | Expandable | Expandable | |
| | Microspheres, | Microspheres, | |
| | 2% | 3% | |
| Hardness, Shore A | 55 | 55 | 55 |
| Specific Gravity | 0.57 | 0.51 | 0.95 |
| T50 (° C.) | 115 | 112 | 115 |

A commercial grade of NEXPRENE 9050D was dry blended with 3 wt % expandable polymeric microspheres in the same manner as Examples 1-2 above. Samples were prepared and measured for compression set and thermal conductivity as described in the text. The thermal conductivity was measured initially and then after immersion in water for 24 hours. Moisture content (i.e., amount of moisture absorbance) was measured by the weight loss after heating the sample to 120° C. for 15 minutes and reported as a percentage, according to ASTM D6980-04. Moisture content was measured initially and then after immersion in water for 24 hours. The results are shown in Table 2, illustrating that a desirable balance of properties for the foamed profile of the current invention is achieved (e.g., lower specific gravity, and lower thermal conductivity) compared to an identical unfoamed profile that does not include the expandable polymeric microspheres, while conventional properties including low moisture absorbance and/or good resilience are retained.

Table 2 also illustrates a comparison between syntactic peroxide-cured TPV foam and syntactic phenolic-cured TPV foam, both of which contained glass beads. Glass beads may be used in the manufacture of foamed profiles with a closed cell structure. Such glass beads, however, are typically sensitive to moisture, which may result in limited reduction of thermal conductivity. In addition, glass beads are found to be susceptible to breakage, e.g., due to high shear when processed in mechanical mixers and extruders, and therefore show poor resiliency. A commercial grade of NEXPRENE 9050D (peroxide-cured) and a commercial grade of NEXPRENE 1050D (phenolic-cured) were compounded with 24% glass beads. Different amounts of expandable beads are typically used compared to glass beads because the former expand while the latter do not. Thus, for example, 3 percent of unexpanded expandable beads and 24 percent of glass beads tend to result in a similar volume of voids after the expandable beads are expanded. The phenolic cured TPV with glass beads was processed at temperatures from about 180° C. to 210° C. in all zones. In addition, the phenolic cured TPV was dried for five hours before extrusion. Attempts to extrude the material without initial drying were unsuccessful. The results show the surprising and unexpected result that foamable blends containing expandable polymeric microspheres have a lower thermal conductivity than the blends containing glass microspheres.

TABLE 2

| | Experiment No. | | | | | |
|---|---|---|---|---|---|---|
| | Ex. 3 | Ex. 4 | Comp. Ex. 2 | Comp. Ex. 3 | Comp. Ex. 4 | Comp. Ex. 5 |
| Curative | Peroxide | Phenolic | Peroxide | Phenolic | Peroxide | Phenolic |
| Foaming agent | Heat | Heat | None | None | Glass beads, | Glass beads, |
| | Expandable | Expandable | | | 24% | 24% |
| | 3% | 3% | | | | |
| Specific Gravity | 0.46 | 0.44 | 0.96 | 0.93 | 0.95 | 0.94 |
| Compression Set | 83 | 84 | 83 | 83 | 91 | 90 |
| (125° C./70 hrs) | | | | | | |
| Extruded tape | 0.08 | 0.14 | 0.08 | 0.1 | 0.11 | 0.13 |
| moisture, % | | | | | | |
| Extruded tape | 1.08 | 1.63 | 0.07 | 0.2 | 1.05 | 1.15 |
| moisture after 24 hrs | | | | | | |
| in water, % | | | | | | |
| Thermal | 0.11 | 0.11 | 0.23 | 0.23 | 0.24 | 0.25 |
| conductivity | | | | | | |
| Thermal | 0.12 | 0.12 | 0.23 | 0.22 | 0.22 | 0.25 |
| conductivity after | | | | | | |
| 24 hours in water | | | | | | |

A reactor grade thermoplastic polyolefin material (HIFAX CA138A) was dry blended with 3 wt % expandable polymeric microspheres in the same manner as Examples 1-2 above. The results in Table 3 show that uncrosslinked thermoplastic material is not a suitable candidate for thermal insulation that may be subjected to hydrostatic pressure due to the high (100%) compression set of the material at high temperatures. The uncrosslinked material is also susceptible to moisture absorbance and, therefore, may typically have a shorter service life in a subsea environment.

TABLE 3

| | Experiment No. | | |
|---|---|---|---|
| | Comp. Ex. 6 | Comp. Ex. 7 | Comp. Ex. 8 |
| Curative | None | None | None |
| Foaming agent | Heat | None | Glass beads, |
| | Expandable | | 24% |
| | 3% | | |
| Specific Gravity | 0.52 | 0.88 | 0.91 |
| Compression Set | 100 | 100 | 100 |
| (125° C./70 hrs) | | | |
| Extruded tape moisture, % | 0.05 | 0.08 | 0.08 |
| Extruded tape moisture after | 1.78 | 0.08 | 1.25 |
| 24 hrs in water, % | | | |
| Thermal conductivity | 0.15 | 0.23 | 0.25 |
| Thermal conductivity after 24 | 0.15 | 0.23 | 0.25 |
| hours in water | | | |

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A foamable thermoplastic vulcanizate blend, or reaction product thereof, comprising:
at least one propylene resin and at least one ethylene/alpha-olefin/non-conjugated diene elastomer, wherein the foamable thermoplastic vulcanizate blend has been dynamically vulcanized via a free-radical initiated or phenolic-based curing system comprising at least one crosslinking agent and at least one co-agent present in an amount sufficient to cure the thermoplastic vulcanizate blend; and
a sufficient amount of expandable polymeric microspheres dispersed therein which encapsulate a gas, liquid, or solid to form a foamed thermoplastic vulcanizate blend having a decreased thermal conductivity upon expansion of the microspheres.

2. The blend of claim 1, wherein the curing system is free-radical initiated and the at least one co-agent comprises multifunctional vinyl monomers, multifunctional acrylates containing at least two acrylate groups, multifunctional methacrylates containing at least two methacrylate groups, metal salts of acrylic esters or methacrylic esters, oximers, allyl esters of cyanurates, isocyanurates, aromatic acids, high vinyl polydienes or polydiene copolymers, multifunctional maleimides containing at least two imide groups, or any combination thereof.

3. The blend of claim 1, wherein the curing system is phenolic-based and the at least one co-agent comprises at least one of a: metal oxide, metal halide, metal carboxylate, or a combination thereof.

4. The blend of claim 1, wherein the expandable polymeric microspheres are present in an amount from about 0.001 weight percent to about 30 weight percent, based on the total weight of the polymers in the blend.

5. The blend of claim 1, wherein the thermal conductivity of the foamed thermoplastic vulcanizate blend is less than about 0.19 W/(m·K).

6. The blend of claim 1, wherein the thermal conductivity of the foamed thermoplastic vulcanizate blend is from about 0.01 W/(m·K) to about 0.16 W/(m·K).

7. A foamed thermoplastic vulcanizate polymer blend, or a reaction product thereof, comprising at least one propylene resin present in an amount from about 10 weight percent to about 85 weight percent and at least one ethylene/alpha-olefin/non-conjugated diene elastomer present in an amount from about 5 weight percent to about 90 weight percent, based on the total weight of the polymer component in the blend, wherein the blend has been dynamically vulcanized via a free-radical initiated curing agent or a phenolic curing agent, and wherein the thermal conductivity of the thermoplastic vulcanizate blend has been decreased by the addition of a sufficient amount of expanded polymeric microspheres.

8. The foamed blend of claim 7, wherein expanded polymeric microspheres are present in an amount from about 0.001 weight percent to about 30 weight percent, based on the total weight of the polymer component in the blend.

9. The foamed blend of claim 7, wherein the thermal conductivity of the foamed blend is less than about 0.19 W/(m·K).

10. The foamed blend of claim 7, wherein the thermal conductivity of the foamed blend is from about 0.01 W/(m·K) to about 0.16 W/(m·K).

11. A method for preparing a foamed thermoplastic vulcanizate blend which comprises:
dry blending a thermoplastic vulcanizate blend, or a reaction product thereof, with an amount of expandable polymeric microspheres; and
melt blending the thermoplastic vulcanizate blend and the amount of expandable polymeric microspheres at a processing temperature from about 120° C. to 205° C. to foam the blend into a foamed thermoplastic vulcanizate blend, wherein the amount of microspheres is sufficient to provide the foamed blend with a thermal conductivity of less than about 0.19 W/(m·K).

12. The method of claim 11, which further comprises extruding the foamed blend out of a die.

13. The method of claim 11, wherein the amount of microspheres is from about 0.001 weight percent to about 30 weight percent of the TPV blend.

14. The method of claim 11, further comprising dynamically vulcanizing a thermoplastic polymer blend comprising at least one propylene resin and at least one ethylene/alpha-olefin/non-conjugated diene elastomer; and pelletizing the blend before dry blending with the expandable polymeric microspheres.

15. The method of claim 11, which further comprises triggering expansion of a propellant contained within the microspheres to expand the microspheres sufficiently to foam the blend into a foamed thermoplastic vulcanizate blend, wherein the amount of microspheres and the expansion thereof are each sufficient to provide the foamed blend with a thermal conductivity of less than about 0.19 W/(m·K).

16. The method of claim 15, wherein the triggering comprises the application of heat, a change in pressure, or a combination thereof to expand the propellant in the microspheres, thereby expanding the microspheres.

17. A method for preparing a foamed thermoplastic vulcanizate blend which comprises:
dynamically vulcanizing a thermoplastic vulcanizate blend, or a reaction product thereof, in a mechanical mixer or extruder,
subsequently adding a sufficient amount of expandable polymeric microspheres to the dynamically vulcanized vulcanizate blend; and
further melt blending the thermoplastic vulcanizate blend with the amount of expandable polymeric microspheres at a processing temperature from about 120° C. to 205° C. to foam the blend into a foamed thermoplastic vulcanizate blend, wherein the amount of microspheres is sufficient to provide the foamed blend with a thermal conductivity of less than about 0.19 W/(m·K).

18. The foamed thermoplastic vulcanizate blend produced by the method of claim 15.

19. The foamed thermoplastic vulcanizate blend produced by the method of claim 11.

20. An extruded sheet, tape, or film of the foamed thermoplastic vulcanizate blend of claim 17.

21. An injected molded sheet, tape, or film of the foamed thermoplastic vulcanizate of claim 17.

22. A thermally insulated pipe comprising a pipe and an extruded, thermally insulating tape comprising the foamed thermoplastic vulcanizate blend of claim 7 disposed around a portion of the pipe.

23. A weather seal formed from the foamed thermoplastic vulcanizate blend of claim 7.

24. A thermally insulated pipe comprising a pipe and an extruded, thermally insulating layer comprising the foamed thermoplastic vulcanizate blend of claim 7 extruded in a tubular shape directly around a portion of the pipe.
